(19) United States
(12) Patent Application Publication
(10) Pub. No.: US 2025/0389892 A1
(43) Pub. Date: Dec. 25, 2025

(54) SYSTEMS AND METHODS FOR FABRICATING A PHOTONIC CHIP-TO-CHIP COUPLING

(71) Applicant: Toyota Motor Engineering & Manufacturing North America, Inc., Plano, TX (US)

(72) Inventors: Paul Donald Schmalenberg, Ann Arbor, MI (US); Ercan Mehmet Dede, Ann Arbor, MI (US); Yuqing Zhou, Ann Arbor, MI (US); Reza Behrou, Ladera Ranch, CA (US); Sean P. Rodrigues, Ann Arbor, MI (US)

(21) Appl. No.: 18/748,689

(22) Filed: Jun. 20, 2024

(51) Int. Cl. G02B 6/136; G02B 27/00

(52) U.S. Cl. CPC G02B 6/136; G02B 27/0012

(57) ABSTRACT

Systems and methods described herein relate to fabricating photonic chip-to-chip couplings. In one embodiment, a system for fabricating a photonic chip-to-chip coupling bonds a substrate to first and second photonic chips. The system also generates, based on images of the bonded substrate and the first and second photonic chips captured by an imaging system, an initial optimum design for a waveguide within the substrate to optically couple the first and second photonic chips. The system also etches a first portion of the waveguide in accordance with the initial optimum design using a laser that polymerizes regions of the substrate. The system also monitors the etching of the first portion of the waveguide via the imaging system and generates an updated optimum design for a second portion of the waveguide that compensates for detected error in the first portion of the waveguide.

### TECHNICAL FIELD

The subject matter described herein relates in general to photonic chip-scale devices and, more specifically, to systems and methods for fabricating a photonic chip-to-chip coupling.

### BACKGROUND

In photonic chip-scale devices, often several small chips are interconnected to exchange light. Complete integration is thwarted by chips performing different functions such as generating coherent light, phase shifting light, and detecting light requiring substrates that are made from different materials. Connecting the chips together can take time, involve expensive equipment, and result in signal loss.

### SUMMARY

Embodiments of a system for fabricating a photonic chip-to-chip coupling are presented herein. In one embodiment, the system comprises a processor and a memory storing machine-readable instructions that, when executed by the processor, cause the processor to control a bonding process that bonds a substrate to first and second photonic chips. The memory also stores machine-readable instructions that, when executed by the processor, cause the processor to generate, based on images of the bonded substrate and the first and second photonic chips captured by an imaging system, an initial optimum design for a waveguide within the substrate to optically couple the first and second photonic chips. The memory also stores machine-readable instructions that, when executed by the processor, cause the processor to control etching of a first portion of the waveguide within the substrate in accordance with the initial optimum design using a laser that polymerizes regions of the substrate. The memory also stores machine-readable instructions that, when executed by the processor, cause the processor to monitor the etching of the first portion of the waveguide via the imaging system and generate an updated optimum design for a second portion of the waveguide that compensates for detected error in the first portion of the waveguide.

Another embodiment is a non-transitory computer-readable medium for fabricating a photonic chip-to-chip coupling and storing instructions that, when executed by a processor, cause the processor to control a bonding process that bonds a substrate to first and second photonic chips. The instructions also cause the processor to generate, based on images of the bonded substrate and the first and second photonic chips captured by an imaging system, an initial optimum design for a waveguide within the substrate to optically couple the first and second photonic chips. The instructions also cause the processor to control etching of a first portion of the waveguide within the substrate in accordance with the initial optimum design using a laser that polymerizes regions of the substrate. The instructions also cause the processor to monitor the etching of the first portion of the waveguide via the imaging system and generate an updated optimum design for a second portion of the waveguide that compensates for detected error in the first portion of the waveguide.

Another embodiment is a method of fabricating a photonic chip-to-chip coupling, the method comprising bonding a substrate to first and second photonic chips. The method also includes generating, based on images of the bonded substrate and the first and second photonic chips captured by an imaging system, an initial optimum design for a waveguide within the substrate to optically couple the first and second photonic chips. The method also includes etching a first portion of the waveguide within the substrate in accordance with the initial optimum design using a laser that polymerizes regions of the substrate. The method also includes monitoring the etching of the first portion of the waveguide via the imaging system and generating an updated optimum design for a second portion of the waveguide that compensates for detected error in the first portion of the waveguide.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is an introductory diagram of a photonic-coupling fabrication process, in accordance with an illustrative embodiment of the invention.

FIG. 2 is a more detailed diagram of a photonic-coupling fabrication process, in accordance with an illustrative embodiment of the invention.

FIGS. 3A and 3B illustrate producing a photonic-crystal design for a waveguide that couples two photonic chips, in accordance with an illustrative embodiment of the invention.

FIG. 4 is a block diagram of a photonic-coupling fabrication system, in accordance with an illustrative embodiment of the invention.

FIG. 5 is a flowchart of a method of fabricating a photonic chip-to-chip coupling, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

Traditional alignment methods for photonic chip-to-chip couplings use nanopositioners to raster scan two connection points until signal is maximized. The ends of the coupling substrate are then held in place, and glue is applied, which can cause minor mispositioning and refractive-index mismatch. For mass manufacturing of photonic chip-scale devices, this process takes too long, and the equipment used for such precise alignment is costly. Newer methods such as 3D printing a photonic wire-bond have been developed, but many of the same challenges remain with this method, especially since the wire-bond must be built in three dimensions (by voxels).

Various embodiments described herein of systems and methods for fabricating a photonic chip-to-chip coupling overcome the shortcomings of the prior art to significantly reduce both the time and the cost involved in fabricating photonic chip-to-chip couplings.

First, the various embodiments reverse the order of fabrication compared with prior-art approaches by bonding a substrate to two photonic chips based on approximate alignment that does not involve expensive nanopositioners and afterward etching a waveguide within the substrate in situ using a laser that polymerizes one or more regions within the substrate, the waveguide optically coupling the two photonic chips. As those skilled in the art are aware, the term “etching” is often used in connection with processes (e.g., surface ablation) that physically remove material from a substrate. In the various embodiments described herein, the term “etching” has a broader meaning that encompasses using a laser to polymerize one or more regions within the substrate.

Second, the various embodiments generate an initial optimum design for a waveguide within the substrate based on images of the bonded substrate and photonic chips captured by an imaging system. Generating the initial optimum design, in some embodiments, includes computing a forward physics-based solution or a field solution and the use of topology optimization (also known as inverse design), which takes the forward physics-based solution or the field solution as input. In some embodiments, the forward physics-based solution is computed using a Finite-Difference Time-Domain (FDTD) simulator. In other embodiments, the field solution is computed using a physics-informed neural network (PINN).

Third, the various embodiments monitor the etching of the waveguide as it is being etched using the imaging system. If the detected error (deviation from the initial optimum design) in the portion of the waveguide etched thus far exceeds a predetermined threshold, etching is temporarily paused, and the optimization process is repeated to generate an updated optimum design for some or all the remainder of the waveguide that compensates for the detected error in the already-etched portion of the waveguide. Etching of the waveguide then resumes in accordance with the updated optimum design until the waveguide is completed, optically coupling the two photonic chips.

In some embodiments, the initial optimum design for the waveguide and/or the updated optimum design for some or all the remainder of waveguide is a photonic-crystal design in which the laser polymerizes a plurality of discrete locations within the substrate to form the waveguide. In some of those embodiments, the distribution, within the substrate, of the plurality of discrete locations is optimized using a genetic algorithm (GA).

The various embodiments described herein greatly speed up the fabrication of photonic chip-to-chip couplings compared with conventional approaches because it is faster and less expensive to bond the substrate and chips based on approximate alignment and to monitor in-situ etching of the waveguide within the substrate and refine the design of the waveguide as needed during the etching process.

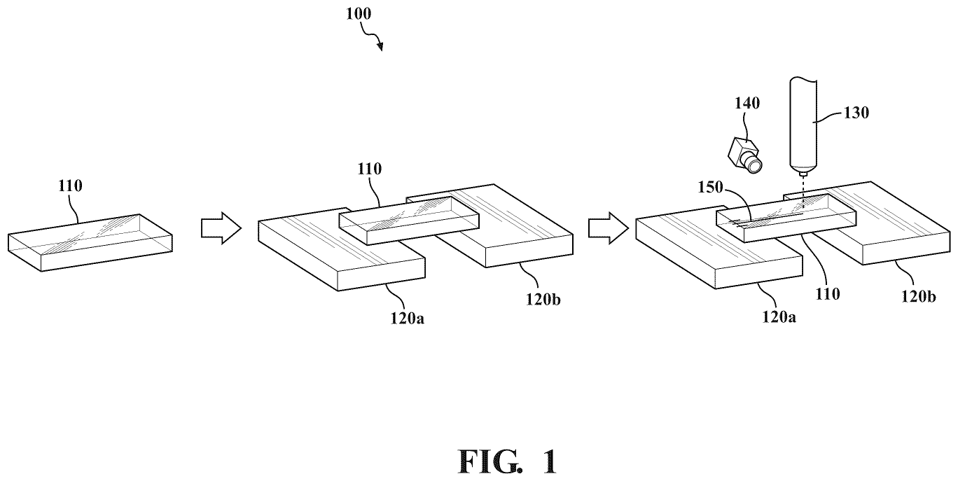

FIG. 1 is an introductory diagram of a photonic-coupling fabrication process 100, in accordance with an illustrative embodiment of the invention. Though fabrication process 100 is somewhat simplified, it illustrates and introduces some of the concepts discussed in greater detail below.

Among other things, FIG. 1 illustrates a substrate 110. In some embodiments and in some situations, the substrate 110 is a semiflex blank substrate. Those skilled in the art are aware that the term “semiflex” refers to the substrate being made of a semiflexible material. Herein, a “semiflex blank substrate” refers to a substrate in which no waveguide has yet been created/etched, though the “blank” substrate may include features such as alignment marks at its corners that are created before the waveguide itself is etched within the substrate 110. The substrate 110 is at least semi-transparent to the wavelength of the polymerization laser and to the wavelength or range of wavelengths of light that will propagate along the waveguide (i.e., the wavelength or wavelengths used by the photonic chips 120). The objective is for the substrate 110 to be as close to lossless as possible for the propagating wavelength or range of wavelengths. Importantly, the substrate 110 is capable of a change in refractive index in its polymerized regions compared with its unpolymerized regions. That difference in refractive index between the polymerized and unpolymerized regions of the substrate 110 is what causes light to propagate along the waveguide, once the waveguide has been etched within the substrate 110. The higher the refractive-index ratio is between the polymerized and unpolymerized regions, the more “confined” the light is within the waveguide. In general, the substrate 110 is made of a polymer. Examples of such a material include, without limitation, polydimethylsiloxane (PDMS) or polyoctalfluoropentylmethacrylate (POFPMA).

FIG. 1 also illustrates the substrate 110 being approximately aligned with and bonded to photonic chip 120a and photonic chip 120b. Approximate alignment can be performed using a pick-and-place machine, for example. The pick-and-place machine is selected and adjusted to achieve an alignment accuracy to within the width of the substrate 110. It does not matter if the alignment of the substrate 110 and one or more of the two photonic chips 120 is at somewhat of an angle because the various embodiments of a photonic-coupling fabrication system described herein can compensate for the misalignment during the design and etching phases of the fabrication process. In some embodiments, optical-glue bonding is used to bond the substrate 110 to the two photonic chips 120a and 120b. In other embodiments, heat-based or ultrasonic-based bonding techniques are used.

FIG. 1 also illustrates that a laser 130 etches a waveguide 150 within the substrate 110 in situ after approximate alignment of the substrate 110 with the photonic chips 120a and 120b and bonding of the substrate 110 to the photonic chips 120a and 120b. The laser 130 is focused within the substrate by an adjustable objective lens (not shown in FIG. 1). An imaging system 140 captures images of the approximately aligned and bonded substrate 110 and photonic chips 120. The images are input to an optimization process that generates an initial design of the waveguide 150, as discussed further below. The imaging system 140 also monitors the etching of the waveguide 150 and supports re-design of the waveguide 150 during etching based on measured etch performance, as also discussed further below.

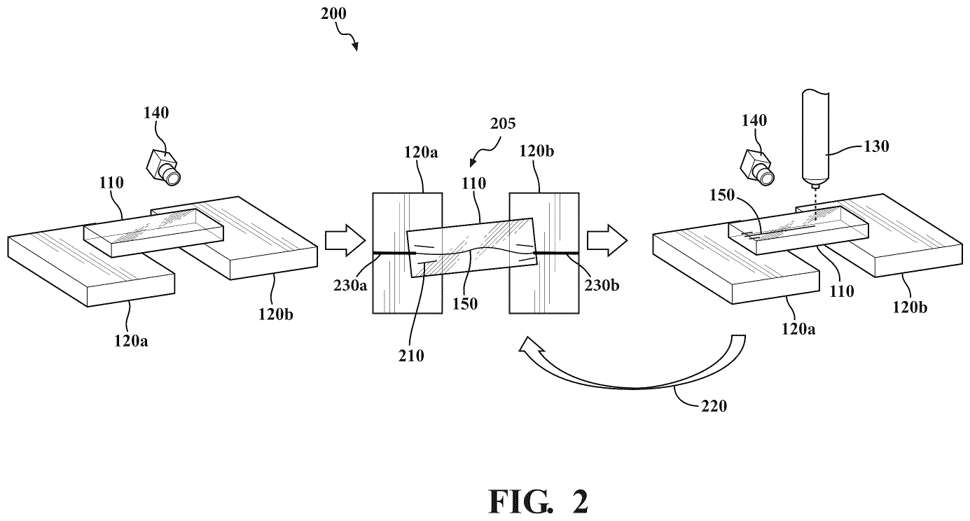

FIG. 2 is a more detailed diagram of a photonic-coupling fabrication process 200, in accordance with an illustrative embodiment of the invention. FIG. 2 adds additional concepts to the simplified fabrication process 100 shown in FIG. 1. In the left portion of FIG. 2, the substrate 110 has been approximately aligned with and bonded to the two photonic chips, photonic chip 120a and photonic chip 120b, as discussed above. Imaging system 140 captures one or more images of the bonded substrate 110 and photonic chips 120. The center portion of FIG. 2 illustrates an initial optimum design 205 for a waveguide 150 based, in part, on the images captured by imaging system 140. As indicated in FIG. 2, in some embodiments, the initial optimum design 205 includes, within the substrate 110, supplemental optical-coupling structures 210 that improve the light coupling between the waveguide 150 and the applicable photonic chip 120. The initial optimum design 205 is that of a waveguide 150 to optically couple the waveguide 230a of photonic chip 120a to the waveguide 230b of the photonic chip 120b. The optimization process that generates the initial optimum design 205 is discussed in greater detail below.

The right portion of FIG. 2 illustrates the in-situ etching of the waveguide 150 within the substrate 110. As mentioned above, the imaging system 140 monitors the etching (polymerizing) of the substrate 110 by the laser 130. The imaging system 140 is designed to distinguish between the polymerized and unpolymerized regions of the substrate 110. If the photonic-coupling fabrication system, via the imaging system 140, detects that the portion of the waveguide 150 etched thus far has deviated from the initial optimum design 205 by greater than a predetermined error threshold, the system temporarily pauses etching by the laser 130, and a re-design process 220 similar to the initial design process is performed to generate an updated optimum design for some or all the remainder of the waveguide 150 that compensates for the detected error in the portion of the waveguide 150 already etched. The system then resumes the etching of the waveguide 150 in accordance with the updated optimum design. In some embodiments, this process of evaluating the waveguide 150 etched thus far via imaging system 140, pausing etching, performing the re-design process 220, and resuming etching in accordance with a refined design is repeated multiple times during the etching of the complete waveguide 150 to couple the two photonic chips 120.

The optimization process that generates the initial optimum design 205 and one or more updated optimum designs thereafter during etching differs somewhat depending on the embodiment. At a high level, the optimization process involves computing a forward physics-based solution or a field solution and a sensitivity analysis such as the adjoint method together with topology optimization (sometimes hereinafter referred to as “TopOpt”) to produce an optimum design for the waveguide 150. As those skilled in the art are aware, topology optimization (also known in the literature as “inverse design”) is a mathematical technique that optimizes the layout of a material within a design space subject to a set of loads, boundary conditions, and constraints with the objective of maximizing the performance of a system. A more detailed overview of the principles and techniques of TopOpt is provided later in this description. As discussed above, in some embodiments, the photonic-coupling fabrication system computes the forward physics-based solution using a FDTD simulator. In other embodiments, a PINN is used in place of the FDTD simulator to compute a field solution. The forward physics-based solution or the field solution and sensitivities are input to the TopOpt process. Each of these two implementations is discussed in greater detail below.

As discussed above, based on one or more images of the bonded substrate 110 and photonic chips 120 captured by imaging system 140, the photonic-coupling fabrication system constructs, in a simulation environment, a model (representation) of the bonded substrate 110 and photonic chips 120. In some embodiments, the simulation environment is a FDTD simulator. In the simulation environment, the system applies TopOpt in designing a waveguide 150 to optically couple the two photonic chips 120.

During each iteration of the TopOpt process, the system solves the forward physics-based solution once and also the adjoint solution that yields the sensitivities for the complete design of the waveguide 150, showing what should be changed for the next iteration of the TopOpt process. Upon completion of the iterative TopOpt process, the system has generated the initial optimum design 205 discussed above. In an embodiment that uses a PINN in place of the FDTD simulator, the field solution output by the PINN is substituted for the forward physics-based solution as input to the iterative TopOpt process just described.

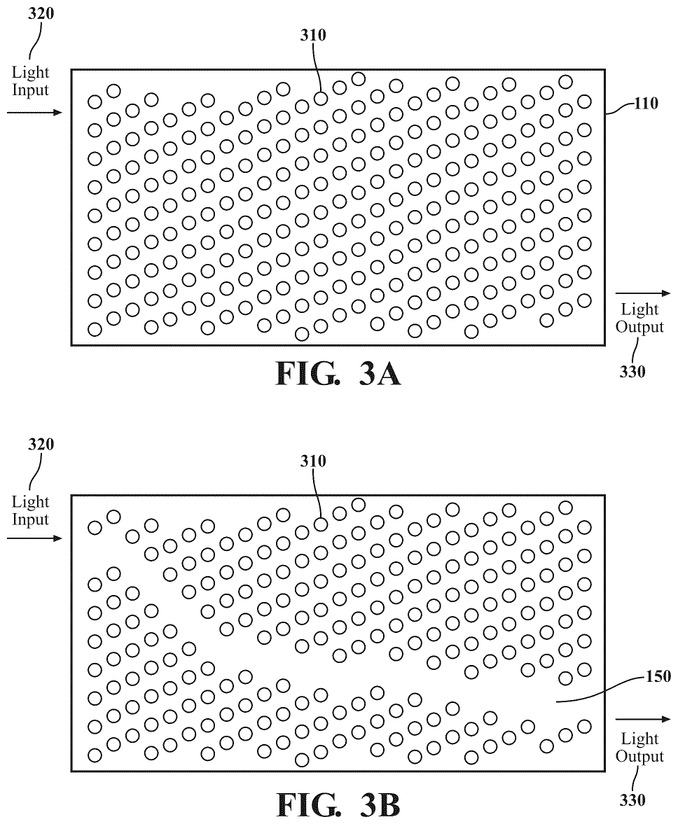

The supplemental optical-coupling structures 210 in FIG. 2 represent structures that enhance the optical coupling between the waveguide 150 and the photonic chips 120. Light is coupled out of plane from one photonic chip 120a into the substrate 110 and then back into the other photonic chip 120b. Such structures operate, in effect, somewhat like an “optical funnel.” The underlying principle is mode matching to account for the different refractive index of the photonic chip 120 compared with that of the substrate 110. In some embodiments, these supplemental optical-coupling structures 210 are constructed using a photonic-crystal design. Embodiments including a photonic-crystal design for the waveguide 150 are discussed in greater detail below in connection with FIGS. 3A and 3B.

As discussed above, in some embodiments a PINN takes the place of the FDTD simulator in producing a field solution that is input to the TopOpt process. In such an embodiment, the inputs to the PINN include, for example, the boundary conditions for the simulation (shape and size of the substrate 110, how the substrate 110 is misaligned with the photonic chips 120, where the photonic chips' inputs and outputs are, the heights of the photonic chips 120, etc.) and the goal/objective (optimization criteria, loss function, etc.). In some embodiments, the neural network is pretrained using a simulation dataset. Ground-truth data for training can be generated using a number of different selected scenarios and corresponding calculated solutions via computer-aided engineering (CAE). The neural-network topology is that of an encoder, in some embodiments. In some embodiments, the neural network is a convolutional neural network (CNN) or a transformer network. A PINN-based embodiment produces inputs for the TopOpt process more rapidly than a FDTD-based embodiment. For example, a PINN-based embodiment permits packaging to be completed within 10 to 30 seconds.

In some embodiments, the photonic-coupling fabrication system etches a continuous waveguide 150 within the substrate 110. In such an embodiment, the waveguide 150 is made up of a continuous or partially continuous polymerized pathway for light within the substrate 110. In other embodiments, the system polymerizes a plurality of discrete locations within the substrate 110 to form the waveguide 150. The latter approach is referred to herein as a “photonic-crystal design” for a waveguide 150. Photonic-crystal designs are described in greater detail below in connection with FIGS. 3A and 3B.

FIGS. 3A and 3B illustrate producing a photonic-crystal design for a waveguide 150 that couples two photonic chips 120, in accordance with an illustrative embodiment of the invention. FIG. 3A illustrates the concept of discrete dot-like polymerized locations 310 within the substrate 110. The polymerized locations 310 shown in FIG. 3A illustrate potential locations where the laser 130 can polymerize the substrate 110. As also shown in FIG. 3A, through design and fabrication of a waveguide 150 (not yet present in FIG. 3A), light input 320 enters the substrate 110 at one end, and light output 330 exits the substrate 110 at the opposite end. In FIG. 3B, laser 130, in accordance with the design for the waveguide 150 produced by the optimization process discussed above, has polymerized a number of discrete locations (310) within substrate 110, and a particular region within substrate 110 has been intentionally left unpolymerized to form a waveguide 150 along which light can propagate through the substrate 110, thereby coupling the photonic chips 120.

In some embodiments, each polymerized location 310 is treated as a member of a population, and the system employs a genetic algorithm (GA) to optimize the distribution of the population (the polymerized locations 310) within the substrate 110.

Note that, in some embodiments, the waveguide 150 is formed by one or more polymerized regions within the substrate 110. In other embodiments, such as the embodiment illustrated in FIG. 3B, the waveguide 150 is formed by one or more unpolymerized regions within the substrate 110. In either case, it is the ratio of refractive indexes between the polymerized and unpolymerized regions that forms the waveguide 150. The TopOpt process can produce either type of design, continuous or discrete (photonic-crystal), for a waveguide 150.

In some embodiments, an optical coupler (waveguide 150) formed by the techniques described herein performs another function in addition to optically coupling the two photonic chips 120. For example, in some embodiments the waveguide 150 functions as a 1×N splitter, a filter, or a resonance cavity in addition to coupling the photonic chips 120. Where the waveguide 150 is a 1×N splitter, the waveguide 150 has a 1×N (one-input, N-output) topology.

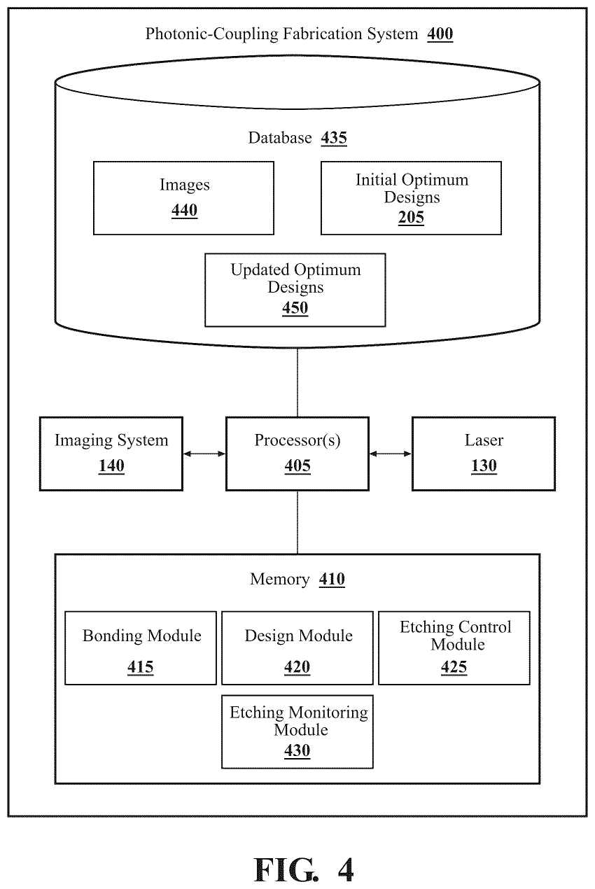

FIG. 4 is a block diagram of a photonic-coupling fabrication system 400, in accordance with an illustrative embodiment of the invention. In FIG. 4, photonic-coupling fabrication system 400 (hereinafter sometimes referred to simply as the “system 400”) includes one or more processors 405 to which a memory 410 is communicably coupled. Memory 410 stores a bonding module 415, a design module 420, an etching control module 425, and an etching monitoring module 430. The memory 410 is a random-access memory (RAM), read-only memory (ROM), a hard-disk drive, a flash memory, or other suitable non-transitory memory for storing the modules 415, 420, 425, and 430. The modules 415, 420, 425, and 430 are, for example, machine-readable instructions that, when executed by the one or more processors 405, cause the one or more processors 405 to perform the various functions disclosed herein. As shown in FIG. 4, the one or more processors 405 communicate with and control imaging system 140 and laser 130.

As also shown in FIG. 4, photonic-coupling fabrication system 400 can store various kinds of data in a database 435. For example, photonic-coupling fabrication system 400 can store images 440 captured by imaging system 140, initial optimum designs 205, and updated optimum designs 450.

Bonding module 415 generally includes instructions that, when executed by the one or more processors 405, cause the one or more processors 405 to control the bonding process that bonds a substrate 110 to first and second photonic chips 120. As discussed above, in some embodiments optical-glue bonding is used to bond the substrate 110 to the two photonic chips 120. In other embodiments, heat-based or ultrasonic-based bonding techniques are used.

Design module 420 generally includes instructions that, when executed by the one or more processors 405, cause the one or more processors 405 to generate, based on images 440 of the bonded substrate 110 and the first and second photonic chips 120 captured by the imaging system 140, an initial optimum design 205 for a waveguide 150 within the substrate 110 to optically couple the first and second photonic chips 120. The design optimization process for the waveguide 150 is discussed in detail above in connection with FIGS. 2, 3A, and 3B. As described above, in some embodiments a simulation environment such as a FDTD simulator computes a forward physics-based solution that is input to the TopOpt (topology optimization) process. In other embodiments, a PINN takes the place of the FDTD simulator, and the PINN computes a field solution that is input to the TopOpt process. As also discussed above, in some embodiments the initial optimum design 205 and/or one or more updated optimum designs for the waveguide 150 is a photonic-crystal design in which the laser 130 polymerizes a plurality of discrete locations (polymerized locations 310) within the substrate 110 to form the waveguide 150 (e.g., as an unpolymerized pathway for light, as illustrated in FIG. 3B). In some of those embodiments, the design module 420 optimizes the distribution, within the substrate 110, of the polymerized locations 310 using a GA (genetic algorithm).

Etching control module 425 generally includes instructions that, when executed by the one or more processors 405, cause the one or more processors 405 to control etching of a first portion of the waveguide 150 within the substrate 110 in accordance with the initial optimum design 205 using a laser 130 that polymerizes regions of the substrate 110. As explained above, the substrate 110 is capable of a change in refractive index in its polymerized regions compared with its unpolymerized regions. That difference in refractive index between the polymerized and unpolymerized regions of the substrate 110 is what causes light to propagate along the waveguide 150, once a waveguide 150 has been formed within the substrate 110. The higher the refractive-index ratio is between the polymerized and unpolymerized regions, the more “confined” the light is within the waveguide 150.

Etching monitoring module 430 generally includes instructions that, when executed by the one or more processors 405, cause the one or more processors 405 to monitor the etching of the first portion of the waveguide 150 via the imaging system 140 and generate an updated optimum design for a second portion of the waveguide 150 that compensates for detected error in the first portion of the waveguide. Etching monitoring module 430 generates the updated optimum design for the waveguide 150 via the design module 420 discussed above.

As discussed above, the imaging system 140 monitors the etching (polymerizing) of the substrate 110 by the laser 130. The imaging system 140 is capable of distinguishing between the polymerized and unpolymerized regions of the substrate 110. If the photonic-coupling fabrication system, via the imaging system 140, detects that the portion of the waveguide 150 etched thus far has deviated from the initial optimum design 205 by greater than a predetermined error threshold, the system temporarily pauses etching by the laser 130, and a re-design process 220 (refer to FIG. 2) is performed to generate an updated optimum design 450 for some or all the remainder of the waveguide 150 that compensates for the detected error in the portion of the waveguide 150 already etched. Via etching control module 425, the system 400 then resumes the etching of the waveguide 150 in accordance with the updated optimum design 450. In some embodiments, this process of evaluating the waveguide 150 etched thus far via imaging system 140, pausing etching, performing the re-design process 220, and resuming etching in accordance with a refined optimum design 450 is repeated multiple times during the etching of the complete waveguide 150 to couple the two photonic chips 120.

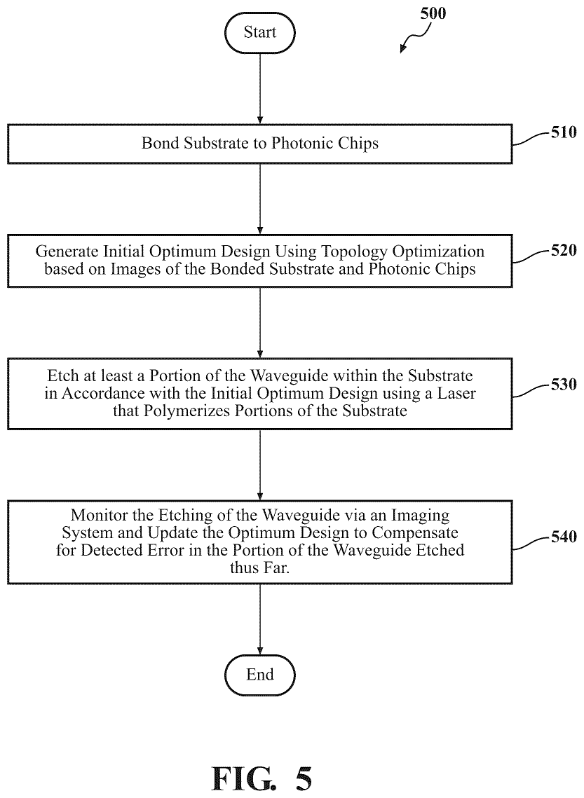

FIG. 5 is a flowchart of a method 500 of fabricating a photonic chip-to-chip coupling, in accordance with an illustrative embodiment of the invention. Method 500 will be discussed from the perspective of photonic-coupling fabrication system 400 in FIG. 4. While method 500 is discussed in combination with photonic-coupling fabrication system 400, it should be appreciated that method 500 is not limited to being implemented within the system 400, but the system 400 is instead one example of a system that may implement method 500.

At block 510, bonding module 415 controls the bonding process that bonds a substrate 110 to first and second photonic chips 120. As discussed above, in some embodiments optical-glue bonding is used to bond the substrate 110 to the two photonic chips 120. In other embodiments, heat-based or ultrasonic-based bonding techniques are used.

At block 520, design module 420 generates, based on images 440 of the bonded substrate 110 and the first and second photonic chips 120 captured by an imaging system 140, an initial optimum design 205 for a waveguide 150 within the substrate 110 to optically couple the first and second photonic chips 120. The design optimization process for the waveguide 150 is discussed in detail above in connection with FIGS. 2, 3A, and 3B. As described above, in some embodiments a simulation environment such as a FDTD simulator computes a forward physics-based solution that is input to the TopOpt process. In other embodiments, a PINN takes the place of the FDTD simulator, and the PINN computes a field solution that is input to the TopOpt process. As also discussed above, in some embodiments the initial optimum design 205 and/or one or more updated optimum designs 450 for the waveguide 150 is a photonic-crystal design in which the laser 130 polymerizes a plurality of discrete locations (polymerized locations 310) within the substrate 110 to form the waveguide 150 (e.g., an unpolymerized pathway for light within substrate 110). In some of those embodiments, the design module 420 optimizes the distribution, within the substrate 110, of the polymerized locations 310 using a GA.

At block 530, etching control module 425 controls etching of a first portion of the waveguide 150 within the substrate 110 in accordance with the initial optimum design 205 using a laser 130 that polymerizes regions of the substrate 110. As explained above, the substrate 110 is capable of a change in refractive index in its polymerized regions compared with its unpolymerized regions. That difference in refractive index between the polymerized and unpolymerized regions of the substrate 110 is what causes light to propagate along the waveguide 150, once a waveguide 150 has been formed within the substrate 110. The higher the refractive-index ratio is between the polymerized and unpolymerized regions, the more “confined” the light is within the waveguide 150.

At block 540, etching monitoring module 430 monitors the etching of the first portion of the waveguide 150 via the imaging system 140 and generates an updated optimum design 450 for a second portion of the waveguide 150 that compensates for detected error in the first portion of the waveguide. Etching monitoring module 430 generates the updated optimum design 450 for the waveguide 150 via the design module 420 discussed above.

As discussed above, the imaging system 140 monitors the etching (polymerizing) of the substrate 110 by the laser 130. The imaging system 140 is capable of distinguishing between the polymerized and unpolymerized regions of the substrate 110. If the photonic-coupling fabrication system, via the imaging system 140, detects that the portion of the waveguide 150 etched thus far has deviated from the initial optimum design 205 by greater than a predetermined error threshold, the system temporarily pauses etching by the laser 130, and a re-design process 220 (refer to FIG. 2) is performed to generate an updated optimum design for some or all the remainder of the waveguide 150 that compensates for the detected error in the portion of the waveguide 150 already etched. Via etching control module 425, the system 400 then resumes the etching of the waveguide 150 in accordance with the updated optimum design 450. In some embodiments, this process of evaluating the waveguide 150 etched thus far via imaging system 140, pausing etching, performing the re-design process 220, and resuming etching in accordance with a refined optimum design 450 is repeated multiple times during the etching of the complete waveguide 150 to couple the two photonic chips 120.

This description next turns to an overview of the principles and mathematical techniques of topology optimization or inverse design that are used in the various embodiments disclosed herein to produce an initial optimum design 205 or re-design (updated design) 450 for a waveguide 150 within the substrate 110. The overview that follows is based on R. Christiansen and O. Sigmund, “Inverse Design in Photonics by Topology Optimization: Tutorial,” Journal of the Optical Society of America B, Vol. 38, No. 2, February 2021, pp. 496-509. Additional details and examples regarding inverse design, as applied to photonics, can be found in that publication.

Solving a structural design problem via inverse design has, as its objective, the identification of a structure that maximizes one or more figures of merit without violating any of the constraints inherent in the problem to be solved.

In the discussion that follows, assume a Cartesian coordinate system to model space, such as r={x, y, z}∈ [symbol] ³ in three dimensions and r={x, y}∈ [symbol] ² in two dimensions, where [symbol] denotes the field of real numbers. To model the underlying physics, a spatially limited modeling domain Ω having an interior Ω_{I} and a boundary Γ can be defined.

In the embodiments disclosed herein, the inverse-design problems are treated as being time-harmonic, and any transient behavior is ignored. A time-harmonic exponential factor, e^{jωt}, is used to model the time dependence, where t represents time, w represents angular frequency, and j is the imaginary unit.

Given the above framework, the following field equations are used for the electric field ε and magnetic field

$$= \frac{1}{{μ}_{0}} : \qquad ( 1 )$$

$$∇ \cdot ε = \frac{ρ}{{ε}_{r} {ε}_{0}} , ∇ \cdot = 0 , ∇ \times ε = - {μ}_{0} \frac{\partial }{\partial t} ,$$

$$∇ \times = {J}_{f} + {ε}_{r} {ε}_{0} \frac{\partial ε}{\partial t} , ε = {Ee}^{j ω t} , = {He}^{j ω t} ,$$

where J_{f} and ρ represent the free-current and free-charge densities; ε₀ and μ₀ represent the vacuum electric permittivity and the vacuum magnetic permeability, respectively; the symbol εᵣ represents the relative electric permittivity of the medium through which the fields ε and [symbol] propagate; and the symbols E and H represent the spatially dependent portion of the electric and magnetic fields, respectively.

In some embodiments, the current and charge densities are assumed to be zero in the interior of the model domain. This means that J_{f}(r)=0 and ρ(r)=0 for r∈Ω_{I}. Based on these assumptions, equations for E and H in Ω_{I} can be derived as follows:

$$∇ \times ∇ \times E ( r ) - \frac{{ω}^{2}}{{c}^{2}} {ε}_{r} ( r ) E ( r ) = 0 , r ∈ {Ω}_{I} ⊂ {ℝ}^{3} \qquad ( 2 )$$

$$∇ \times ( \frac{1}{{ε}_{r} ( r )} ∇ \times H ( r ) ) - \frac{{ω}^{2}}{{c}^{2}} H ( r ) = 0 , r ∈ {Ω}_{I} ⊂ {ℝ}^{3} . \qquad ( 3 )$$

In Eqs. (2) and (3) above, the speed of light in a vacuum is denoted as

$$c = \frac{1}{\sqrt{{μ}_{0 {ε}_{0}}}} .$$

In some embodiments, additional problem-specific boundary conditions in addition to Eqs. (2) and (3) can be imposed on the boundary of the model domain I to account for external fields and to appropriately truncate it.

In some embodiments, a two-dimensional (2D) model can be applied instead of the above three-dimensional model. That is, material invariance in the out-of-plane direction (i.e., the z direction) can be assumed. Further, in some embodiments, it can also be assumed that the E or H field is linearly polarized in the z direction so that the above relationships can be reduced to the following scalar Helmholtz equation in two dimensions:

$${ℒ}_{EM} ( ϕ ) = ∇ \cdot ( a ∇ ϕ ) + \frac{{ω}^{2}}{{c}^{2}} b ϕ = 0 , r ∈ {Ω}_{I} ⊂ {ℝ}^{2} . \qquad ( 4 )$$

In embodiments in which it is necessary to model an E_{z}-polarized field (Eₓ=E_{y}=0) (hereinafter “TE”), ϕ=E_{z}, a=1, and b=εᵣ. In the case of a problem including an H_{z}-polarized field (Hₓ=H_{y}=0) (hereinafter “TM”),

$$ϕ = {H}_{z} , a = \frac{1}{{ε}_{r}} , and b = 1.$$

As those skilled in the art will recognize, given the solution to Eq. (4) above, ε and [symbol] (E and H) can be computed using Eq. (1).

To solve any structural design problem using inverse design, the problem is defined as a continuous constrained optimization problem, which can be express formally as follows:

$${max}_{ξ} Φ ( ξ ) , Φ {: [ 0 , 1 ]}^{{Ω}_{d}} \to ℝ , \qquad ( 5 )$$

$$s . t . {c}_{i} ( ξ ) = 0 , {c}_{i} {: [ 0 , 1 ]}^{{Ω}_{d}} \to ℝ , i ∈ \{ 0 , 1 , ... , \} , ∈ {ℕ}_{0} ,$$

$${c}_{j} ( ξ ) < 0 , {c}_{j} {: [ 0 , 1 ]}^{{Ω}_{d}} \to ℝ , , j ∈ \{ 0 , 1 , ... , {𝒩}_{j} \} , {𝒩}_{j} ∈ {ℕ}_{0} .$$

In problem definition of Eq. (5), ξ(r)∈[0,1] represents a continuous field sometimes referred to as the “design field” with respect to which the function, the figure of merit (hereinafter “FOM”), is to be maximized. In Eq. (5), the cᵢ(ξ)=0 and cⱼ(ξ)<0 relationships denote [symbol] equality constraints and [symbol] inequality constraints, respectively. In formulating an inverse design problem, it is important to select a FOM (e.g., Φ(ξ) in Eq. (5)) that reliably measures the performance of the structure being designed. In the thermally modulated photonic switch example, the FOM can be described as maximizing the time averaged power flow from the input waveguide into one of the N output waveguides, depending on the N distinct predetermined temperatures.

Different FOMs could be employed in solving the above illustrative problem, but what they have in common is that they can be written as simple functions of the electric field, the magnetic field, or both evaluated with respect to points, lines, or areas.

Also, the state equation(s) such as Eq. (4) above can be conceptualized as a set of equality constraints as follows:

$${ℒ}_{k} ( {x}_{k} ) = {f}_{k} , k ∈ \{ 1 , 2 , ... , \} , ∈ ℕ , \qquad ( 6 )$$

where the [symbol] operator applies the characteristics of the physical system to the state field xₖ for a given excitation fₖ.

In solving an optimization problem in the form shown above in Eq. (5), the continuous design field ξ(r) is used to interpolate the material parameters modeled by the state equation between the background material(s) and the material(s) constituting the structure under design. Which material interpolation techniques are used depends on the particular problem. In the thermally modulated photonic switch example, the following interpolation functions can be used to interpolate between silicon dioxide and silicon at N distinct predetermined temperatures:

$${ε}_{r}^{N} ( ξ ( r ) ) = {ε}_{r , Si}^{N} + ξ ( r ) ( {ε}_{r , {SiO}_{2}} - {ε}_{r , Si}^{N} ) , \qquad ( 7 )$$

where

$${ε}_{r , Si}^{N} and {ε}_{r , {SiO}_{2}}$$

represent the relative permittivity of silicon and silicon dioxide, respectively. In this case,

$$ξ = 0 ⇔ {ε}_{r} = {ε}_{r , Si}^{N} , and ξ = 1 ⇔ {ε}_{r} = {ε}_{r , {SiO}_{2}} .$$

In some computer-software-based inverse-design implementations, gradient-based algorithms are employed. For example, in some embodiments a technique sometimes referred to in the literature as the “Method of Moving Asymptotes (MMA)” is used. MMA is a gradient-based method for solving constrained nonlinear optimization problems. To overcome the computational difficulties associated with finite differences, some embodiments make use of adjoint sensitivity analysis, which requires solving only one equation for the FOM and an additional equation for each constraint in the optimization problem, regardless of how large the design space happens to be. In one embodiment, COMSOL Multiphysics software (https://www.comsol.com/) is used to solve the physics equilibrium, and MATLAB (https://www.mathworks.com/) is used to perform the iterative optimization updates.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The components described above can be realized in hardware or a combination of hardware and software and can be realized in a centralized fashion in one processing system or in a distributed fashion where different elements are spread across several interconnected processing systems. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” As used herein refers to and encompasses any and all possible combinations of one or more of the associated listed items. As an example, the phrase “at least one of A, B, and C” includes A only, B only, C only, or any combination thereof (e.g. AB, AC, BC or ABC).

As used herein, “cause” or “causing” means to make, command, instruct, and/or enable an event or action to occur or at least be in a state where such event or action may occur, either in a direct or indirect manner.

Aspects herein can be embodied in other forms without departing from the spirit or essential attributes thereof. Accordingly, reference should be made to the following claims rather than to the foregoing specification, as indicating the scope hereof.

What is claimed is:

1. A system for fabricating a photonic chip-to-chip coupling, the system comprising:
a processor; and
a memory storing machine-readable instructions that, when executed by the processor, cause the processor to:
control a bonding process that bonds a substrate to first and second photonic chips;
generate, based on images of the bonded substrate and the first and second photonic chips captured by an imaging system, an initial optimum design for a waveguide within the substrate to optically couple the first and second photonic chips;
control etching of a first portion of the waveguide within the substrate in accordance with the initial optimum design using a laser that polymerizes regions of the substrate; and
monitor the etching of the first portion of the waveguide via the imaging system and generate an updated optimum design for a second portion of the waveguide that compensates for detected error in the first portion of the waveguide.

2. The system of claim 1, wherein the machine-readable instructions include further instructions that, when executed by the processor, cause the processor to control etching of the second portion of the waveguide within the substrate in accordance with the updated optimum design.

3. The system of claim 1, wherein the substrate is a semiflex blank substrate and the waveguide is one of a 1×N splitter, a filter, and a resonance cavity.

4. The system of claim 1, wherein the machine-readable instructions to generate an initial optimum design for the waveguide include instructions to employ topology optimization and to compute one of a forward physics-based solution and a field solution.

5. The system of claim 4, wherein the forward physics-based solution is computed using a Finite-Difference Time-Domain simulator.

6. The system of claim 4, wherein the field solution is computed using a physics-informed neural network.

7. The system of claim 1, wherein the initial optimum design for the waveguide is a photonic-crystal design in which the laser polymerizes a plurality of discrete locations within the substrate to form the waveguide.

8. The system of claim 7, wherein a distribution within the substrate of the plurality of discrete locations is optimized using a genetic algorithm.

9. A non-transitory computer-readable medium for fabricating a photonic chip-to-chip coupling and storing instructions that, when executed by a processor, cause the processor to:
control a bonding process that bonds a substrate to first and second photonic chips;
generate, based on images of the bonded substrate and the first and second photonic chips captured by an imaging system, an initial optimum design for a waveguide within the substrate to optically couple the first and second photonic chips;
control etching of a first portion of the waveguide within the substrate in accordance with the initial optimum design using a laser that polymerizes regions of the substrate; and
monitor the etching of the first portion of the waveguide via the imaging system and generate an updated optimum design for a second portion of the waveguide that compensates for detected error in the first portion of the waveguide.

10. The non-transitory computer-readable medium of claim 9, wherein the instructions include further instructions that, when executed by the processor, cause the processor to control etching of the second portion of the waveguide within the substrate in accordance with the updated optimum design.

11. The non-transitory computer-readable medium of claim 9, wherein the instructions to generate an initial optimum design for the waveguide include instructions to employ topology optimization and to compute one of a forward physics-based solution and a field solution.

12. The non-transitory computer-readable medium of claim 9, wherein the initial optimum design for the waveguide is a photonic-crystal design in which the laser polymerizes a plurality of discrete locations within the substrate to form the waveguide.

13. The non-transitory computer-readable medium of claim 12, wherein a distribution within the substrate of the plurality of discrete locations is optimized using a genetic algorithm.

14. A method, comprising:
bonding a substrate to first and second photonic chips;
generating, based on images of the bonded substrate and the first and second photonic chips captured by an imaging system, an initial optimum design for a waveguide within the substrate to optically couple the first and second photonic chips;
etching a first portion of the waveguide within the substrate in accordance with the initial optimum design using a laser that polymerizes regions of the substrate; and
monitoring the etching of the first portion of the waveguide via the imaging system and generating an updated optimum design for a second portion of the waveguide that compensates for detected error in the first portion of the waveguide.

15. The method of claim 14, further comprising etching the second portion of the waveguide within the substrate in accordance with the updated optimum design.

16. The method of claim 14, wherein generating an initial optimum design for the waveguide includes employing topology optimization and computing one of a forward physics-based solution and a field solution.

17. The method of claim 16, wherein the forward physics-based solution is computed using a Finite-Difference Time-Domain simulator.

18. The method of claim 16, wherein the field solution is computed using a physics-informed neural network.

19. The method of claim 14, wherein the initial optimum design for the waveguide is a photonic-crystal design in which the laser polymerizes a plurality of discrete locations within the substrate to form the waveguide.

20. The method of claim 19, wherein a distribution within the substrate of the plurality of discrete locations is optimized using a genetic algorithm.
